(19) United States
(12) Patent Application Publication
(10) Pub. No.: US 2012/0198707 A1
(43) Pub. Date: Aug. 9, 2012

(54) Cutlery Implement with Release Bumps

(75) Inventor: Lars Blacken, Roswell, GA (US)

(73) Assignee: Calphalon Corporation, Atlanta, GA (US)

(21) Appl. No.: 13/024,107

(22) Filed: Feb. 9, 2011

(51) Int. Cl. B26B 9/00; A47J 17/00

(52) U.S. Cl. 30/346

(57) ABSTRACT

A cutlery implement has a blade with opposed side surfaces and a knife edge along one terminal edge of the blade. One or more bumps protrude from at least one or both of the opposed side surfaces and are arranged along the blade and spaced from the knife edge

### BACKGROUND

1. Field of the Disclosure

The present invention is generally directed to cutlery implements, and more particularly to implements such as knives whereby a blade of the knife has bumps or protrusions thereon to help release cut objects from the blade.

2. Description of Related Art

Many different types of cutlery implements are known in the art. Many cutlery implements are knives configured for use in kitchens for cutting food. It is well known that some types of food, after being cut, tend to stick to the blade of the knife or other implement. Manufacturers have attempted a number of solutions to help release food or other cut items from the blade.

In one example, a blade is provided with a plurality of kullens along the length and placed near the knife edge of the blade. Kullens are depressions or recesses formed into the material of the knife blade. The theory is to decrease the surface area of the flat side surfaces on the knife blade, thus reducing surface friction between the blade and food lying against the blade after being cut. In another example, knives are known to have a Granton-style blade. This type of blade has a plurality of intermittently spaced scallops that are formed in the side surfaces of the knife blade, similar to kullens. However, in a Granton blade, the depressions or scallops continue right to the knife edge. Kullens are typically spaced from the knife edge. Granton blades and kullens are typically formed by grinding material from the blade substrate or by using other material removal processes to remove material from the side of the blade. Material removal creates these intermittently spaced surface depressions, scallops, or recesses.

For many types of food, these solutions do not perform as intended or as claimed by the manufacturers. With certain types of foods, the pockets or recesses formed in the side surfaces of the blade actually create additional suction, i.e., a small vacuum, between the food and the depression. The suction can actually make release of the food item from the blade less likely than even on a standard flat or unaltered blade.

A limited number of manufacturers offer kitchen cutlery that employ specialized paint or another non-stick coating on the surfaces of the blade. It has been found that food release performance for these types of solutions is negligible at best when compared to a standard, uncoated blade.

### SUMMARY

In one example according to the teachings of the present invention, a cutlery implement has a blade with opposed side surfaces and a knife edge along one terminal edge of the blade. A bump protrudes from one or both of the opposed side surfaces. The bump or bumps extend along and are spaced from the knife edge.

In one example, the cutlery implement can have a handle coupled to the blade.

In one example, the cutlery implement can have a distal end on the blade and a grip end opposite the distal end. A handle can be positioned at the grip end and can be oriented substantially parallel with the blade.

In one example, the cutlery implement can have a distal end on the blade and a grip end opposite the distal end. A handle can be located at the grip end and the handle can be oriented substantially parallel with the knife edge.

In one example, the bump r bumps can include a plurality of bumps spaced equidistant apart on each of opposed side surfaces.

In one example, the bump or bumps can include a plurality of elongate bumps arranged lengthwise end to end along each of the opposed side surfaces.

In one example, the bump or bumps can include a plurality of oval or non-round bumps arranged lengthwise side to side along each of the opposed side surfaces.

In one example, the bump or bumps can include a plurality of bumps arranged in a spaced apart array arranged lengthwise along the blade on each of the opposed side surfaces.

In one example, the bump or bumps can include a plurality of circular bumps arranged spaced apart lengthwise along the blade on each of the opposed side surfaces.

In one example, the bump or bumps can include a plurality of bumps spaced apart along each of the opposed side surfaces.

In one example, the cutlery implement can include a plurality of depressions intermittently positioned between a plurality of the bumps on each of the opposed side surfaces.

In one example, the cutlery implement can include a plurality of depressions and plurality of the bumps on one of the opposed side surfaces, which can be aligned to oppose a corresponding one of a plurality of the bumps and a plurality of depressions, respectively, on the other of the opposed side surfaces.

In one example, the bump or bumps can include at least one bump on each of the opposed side surfaces. A corresponding depression can be aligned with each of the bumps on the opposite one of the opposed side surfaces.

In one example, the bump or bumps can have a rounded or continuously curved profile shape.

In one example, the bump or bumps can have an angular profile shape with linear surfaces and a peak.

In one example according to the teachings of the present invention, a cutlery implement has a blade with opposed side surfaces, a distal end, a grip end opposite the distal end, and a knife edge along at least part of one terminal edge of the blade between the distal and grip ends. A handle can extend from the grip end of the blade. A plurality of bumps protrudes from and can be arranged lengthwise along each of the opposed side surfaces spaced from the knife edge.

In one example, the handle can be oriented substantially parallel with the blade.

In one example, the cutlery implement can include a plurality of depressions disposed intermittently between the plurality of bumps on each of the opposed side surfaces.

In one example, each of the plurality of depressions and plurality of bumps on one of the opposed side surfaces can be widthwise aligned with a corresponding one of the plurality of bumps and plurality of depressions, respectively, on the other of the opposed side surfaces on the blade.

In one example according to the teachings of the present invention, a cutlery implement has a blade with opposed side surfaces and a knife edge along one terminal edge of the blade. One or more bumps can from one of the opposed side surfaces or both of the opposed side surfaces and can be arranged lengthwise along and spaced from the knife edge.

In one example, the cutlery implement can include one or more depressions on the other or both of the opposed side surfaces. The depressions can correspond in number with and be positioned opposite the one or more bumps.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of a cutlery implement constructed in accordance with the teachings of the present invention.

FIG. 2 shows a side view of the implement shown in FIG. 1.

FIG. 3 shows a blade and the view of the implement shown in FIG. 1.

FIG. 4 shows a cross section taken along line 4-4 of the implement shown in FIG. 3.

FIG. 5 shows a cross section taken along line 5-5 of the implement shown in FIG. 3.

FIG. 6 shows a perspective view of another example of a cutlery implement constructed in accordance with the teachings of the present invention.

FIG. 7 shows a side view of the implement shown in FIG. 6.

FIG. 8 shows a cross-section taken along line 8-8 of the implement shown in FIG. 7.

FIG. 9 shows a perspective view of another example of a cutlery implement constructed in accordance with the teachings of the present invention.

FIG. 10 shows a side view of the implement shown in FIG. 9.

FIG. 11 shows a cross section taken along line 11-11 of the implement shown in FIG. 10.

FIG. 12 shows a perspective view of another example of a cutlery implement constructed in accordance with the teachings of the present invention.

FIG. 13 shows a side view of the implement shown in FIG. 12.

FIG. 14 shows a cross section taken along line 14-14 of the implement shown in FIG. 13.

### DETAILED DESCRIPTION OF THE DISCLOSURE

Cutlery implements are disclosed and described herein which solve or improve upon one or more of the above-noted and/or other problems and disadvantages with prior known cutlery implements. In one example, the disclosed cutlery implements have a bump or protrusion on at least one side surface of the blade and spaced from the knife edge of the blade. In one example, the disclosed cutlery implements have a bump or protrusion on each of the side surfaces of the blade. In one example, the disclosed cutlery implements have multiple bumps or protrusions on each of the side surfaces of the blade. In one example, the disclosed cutlery implements have a plurality of depressions spaced intermittently between the bumps or protrusions on each side surface of the blade. In one example, the disclosed cutlery implements are kitchen cutlery in the form of otherwise ordinary knives.

The bumps or protrusions on the side surfaces of the blade reduce the surface area of the flat side surface, similar to prior known kullen or Granton blade solutions. However, the bumps or protrusions also do not create vacuum-forming pockets or depressions but instead help to separate food from the blade surfaces by creating an irregular surface-to-surface contact barrier therebetween. Because the bumps or protrusions help to separate or displace the food from the blade side surfaces, the food is less likely to stick to the blade and instead will more easily release therefrom. These and other objects, features, and advantages of the present invention will become apparent to those having ordinary skill in the art upon reading this disclosure.

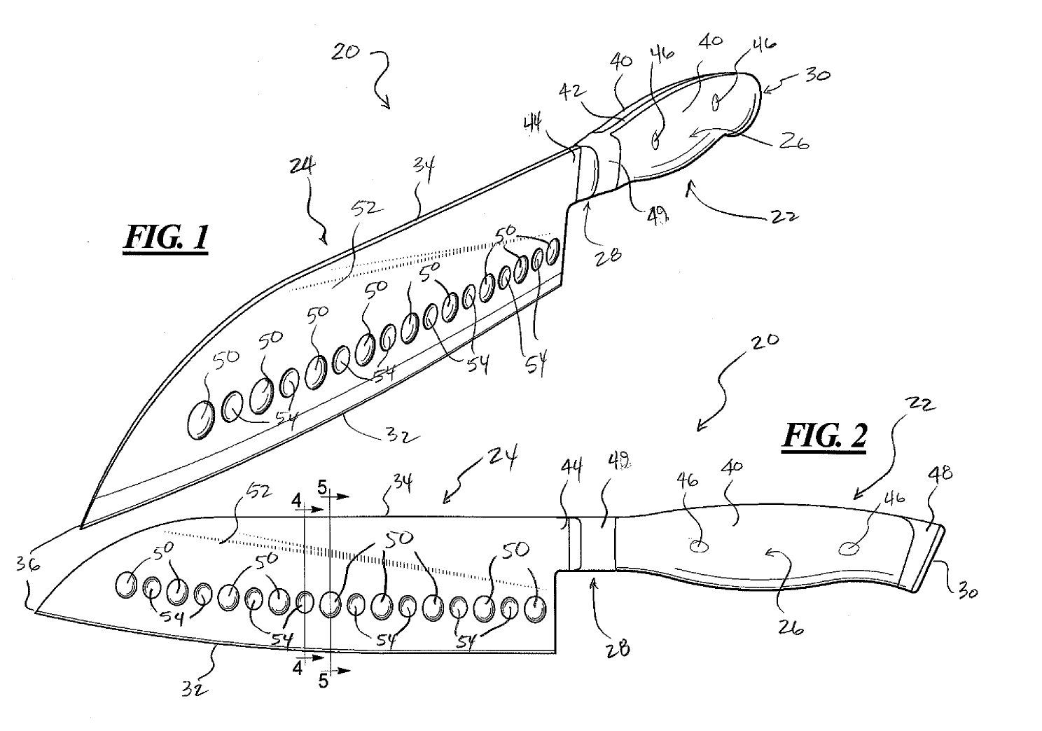

Turning now to the drawings, FIGS. 1 and 2 illustrate a cutlery implement constructed in accordance with the teachings of the present invention. In a disclosed example, the cutlery implement is in the form of a knife 20. The knife 20 generally has a handle section or handle 22 and a blade section or blade 24 oriented generally end to end along a lengthwise axis of the implement. The handle 22 is an elongate structure configured for gripping by a user's hand. The handle 22 therefore has a grip 26 between a proximal end 28 connected to the blade 24 and a free or distal end 30. The grip can be configured to ergonomically conform to a user's hand, but the size and shape of the grip 26 and handle 22 can vary widely within the spirit and scope of the present invention.

The blade 24 generally has a knife edge 32 formed along one lengthwise edge defined herein is the bottom edge. The blade 24 also generally has a blunt top edge 34 generally opposite the knife edge 32. In this example, the blunt edge 34 curves downward, moving forward, toward the knife edge 32 until the two edges meet at a tip or point 36 of the blade. As is known in the art, the knife edge 32 tapers to a very fine or sharp edge to be used for cutting objects, such as food. The thickness of the blade at the blunt edge is wider than the thickness of the blade at the knife edge. The blade can gradually taper from the thinner knife edge 32 to the thicker blunt edge 34. Alternatively, the knife edge 32 can be ground down or form as a much smaller tapered portion of the overall blade height, if desired. On such a blade, the remaining height portion of the blade can have a generally consistent thickness.

The handle 22 can be formed and coupled to the blade 24 in any number of ways. In a disclosed example, the handle 22 has a pair of grip sections 40 that can be produced from any suitable or desired material and shaped to define the overall grip 26. The grip sections 40 can be formed from a material selected for its aesthetic appearance, color, grip enhancing surface characteristics, durability, or a combination thereof. The blade 24 in this example has an extension 42 that continues rearward from a proximal end 44 of the blade itself. As discussed in greater detail below, the blade 24 can be formed as a unitary structure from a steel or other suitable material inclusive of the blade 24 and extension 42. The grip sections 40 can be secured to the extension 42 to complete the form of the grip 26 as is known in the art. In one example, protrusions 46 can be formed integral with and extend laterally outward from each side of the extension 42 of the blade material or can be attached thereto during manufacture of the blade 24. These protrusions 46 can extend through openings (not shown) in the grip sections 40 to attach the grip sections. The exposed ends of the protrusions 46 then can be ground, spun, swaged, or the like to become flush with the surface of the grip sections 40 in order to secure the grip sections to the extension of the blade 24.

The grip 26 can alternatively be formed integrally from the same blade material or the separate grip sections 40, if used, can be secured to the blade extension 42 in any number of suitable ways, such as by screws, rivets, welding, or the like. Also, the handle 22 can be a completely separate component from the blade 24 and attached or otherwise secured to the blade during manufacture, such as by welding, or by use of fasteners. The extension 42 can include widthwise protruding features or elements 48, 49 that complement the shape, or define the shape, of the grip sections 40 when adhered to the extension 42. These protruding elements or features 48, 49 can be configured compliment and/or complete the shape and contour of the handle 22 when the knife is assembled.

The above-noted aspects of the knife 20 disclosed herein can vary considerably within the spirit and scope of the present invention. The configuration construction of the handle 22 can vary in many ways, as can the size and location of the handle relative to the blade 24. The size, shape, and construction of the blade 24 can also very considerably and yet fall within the spirit and scope of the present invention. The materials used to construct the blade 24, as noted in greater detail below, can also vary considerably. The blade 24 can also be formed from non-metallic or non-steel materials.

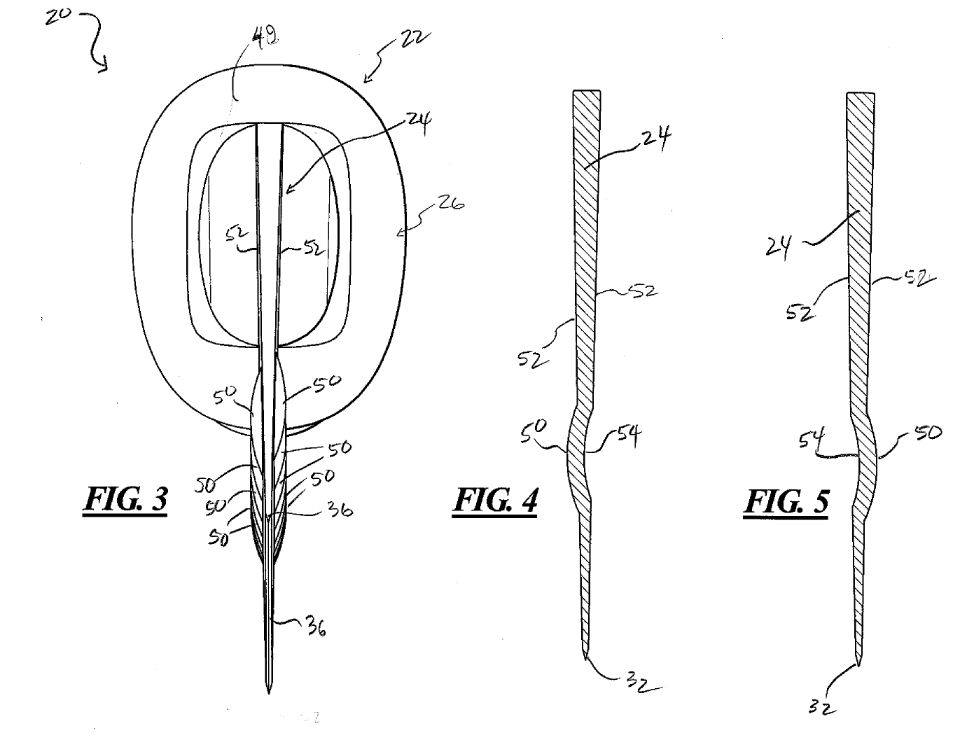

As shown in FIGS. 1 and 2, the disclosed blade 24 has a plurality of bumps or protrusions 50 positioned extending lengthwise therealong and protruding from side surfaces 52 of the blade. In this example, each of the bumps 50 is generally circular in shape as shown in FIG. 2 and has a semi-spherical or domed protruding surface as shown in FIG. 3. Each of the bumps 50 in this example is spaced from but generally near the knife edge 32. A plurality of kullens or dimples 54 are intermittently spaced between the bumps 50 on each side surface 52 of the blade 24 in this example. The kullens 54 are optional in this example and are depicted to show the result of one potential manufacturing process that can be utilized to form the bumps 50 in the blade material. With reference to FIGS. 4 and 5, each of the bumps 50 can be formed during a forging process in a forging die. In one example, a number of the depressions or kullens 54 can be formed on each side surface 52 of the blade 24 by adding protrusions to the forging tool dies. Formation of each of the kullens or depressions 54 in one side surface 52 produces a corresponding one bump 50 on the opposite side surface of the blade 24. Alternatively, the forging tool dies can be constructed with reliefs in the die surfaces so as to only produce a plurality of bumps 50 on each of the side surfaces 52 of the blade 24, thereby not yielding or producing any of the optional depressions or kullens 54.

In the disclosed example, the bumps 50 are intermittently spaced relative to one another along the lengthwise direction of the blade 24. The number of bumps 50 can vary with the spirit and scope of the present invention. The raised height or depth of the bumps 50 can also vary within the spirit and scope of the present invention and can be configured according to a predetermined specific intended use for a particular cutlery implement or knife. The size and shape of the bumps 50 can also vary from the example shown and described herein. In this example, each of the bumps 50 has a circular shape protruding from the corresponding side surface 52 of the blade 24 and has a generally semi-spherical surface contour. The spacing of the bumps 50 can also differ among different types of knives or cutlery implements. Intended usage for a given implement may determine the desired size, shape, height, and/or spacing of the bumps 50.

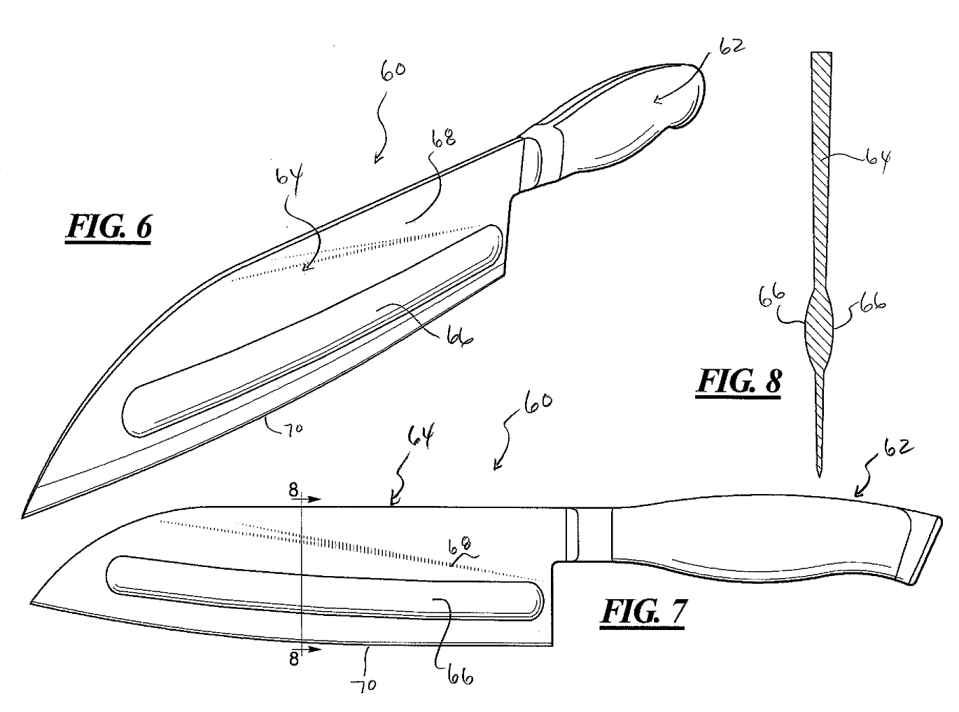

FIGS. 6-8 illustrate another example of a cutlery implement or knife 60 constructed in accordance with the teachings of the present invention. In this example, the knife 60 has a handle 62 and a blade 64 constructed similarly to the prior example. However, in this example the previously described kullens or depressions 54 are absent and the bumps 50 are replaced by a single lengthwise bump 66 extending along a majority of the length of the blade 64. The bumps 66 have a similar curved, domed or semi-spherical shape in cross-section when compared to the bumps 50 of the prior example, but only when viewed in the lengthwise direction of the blade 64 as shown in FIG. 8. Each bump 66 of this example is one continuous, lengthwise protruding feature extending from a respective side surface 68 of the blade 64. In this example, each of the bumps 66 is again spaced from a knife edge 70 of the blade.

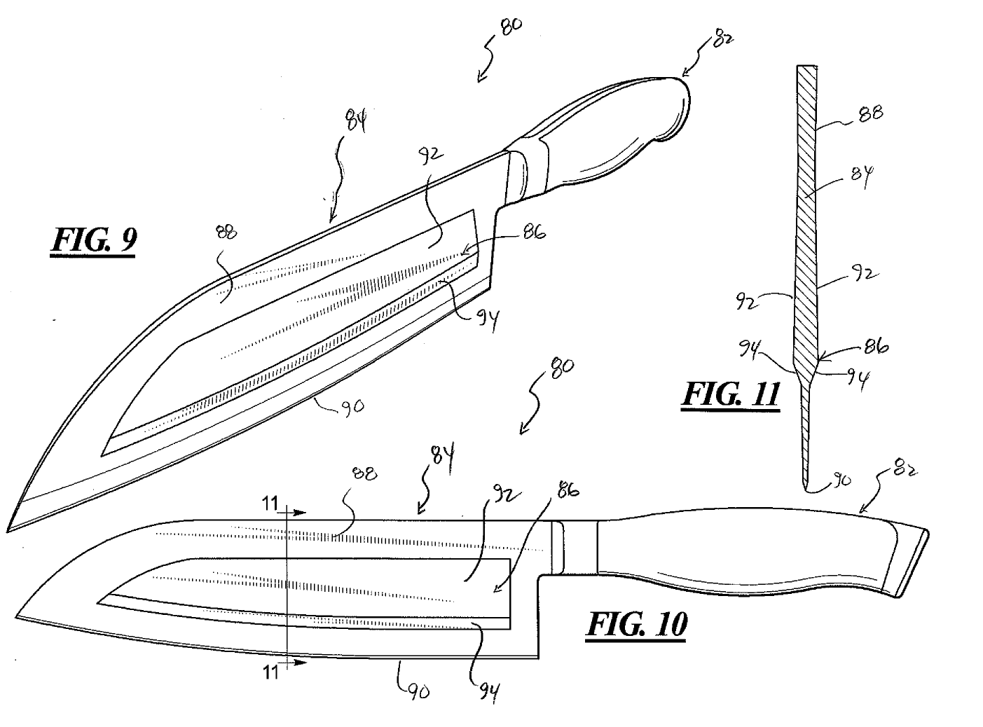

FIG. 9-11 illustrate yet another example of a cutlery implement or knife 80 constructed in accordance with the teachings of the present invention. In this example, the knife 80 also has a handle 82 and a blade 84 similarly constructed to the prior examples. However, in this example, an alternate bump configuration is again employed on the blade 84. A single, continuous, elongate bump 86 is again provided lengthwise on each side surface 88 of the blade 84. Each bump 86 is again spaced from a knife edge 90 on the blade. The bumps 86 in this example are similar to the bumps 66 of the prior example in that they are a single continuous lengthwise extending protrusion. However, in this example, each of the bumps 86 has a different cross-section or profile shape. As shown in FIGS. 10 and 11, each of the bumps 86 has an angular shape with linear surface elements. Each bump 86 has an upper surface portion 92 that gradually angles and smoothly transitions outward from the side surface 88. Each bump 86 also has a more sharply angled lower surface portion 94. The angular surface portions 92 and 94 of each of the bumps 86 in this example, though different from the semi-spherical curved or domed shape of the bumps in the prior examples, will function in an essentially identical manner. The angle of the lower surface portion 94, as well as the overall depth or raised height of the bumps 86, can be varied to accommodate different materials to be cut.

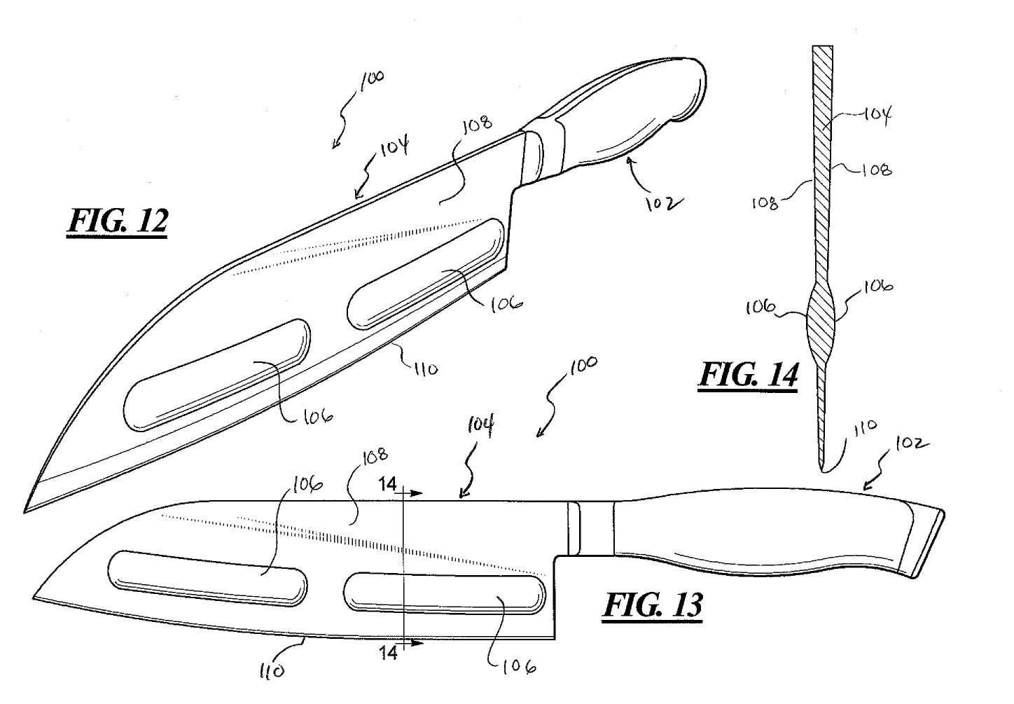

FIGS. 12-14 illustrate still another example of a cutlery implement or knife 100 constructed in accordance with the teachings of the present invention. In this example, the knife 100 also has a handle 102 and a blade 104 similarly constructed to the prior examples. However, in this example another alternate bump configuration is employed on the blade 104. A pair of elongate bumps 106 are arranged lengthwise aligned along each side surface 108 of the blade 104 in this example. Each of the bumps 106 protrudes from the side surface 108 and is again spaced from a knife edge 110 of the blade. The bumps 106 on each side surface 108 are lengthwise aligned with one another but are also spaced apart from one another on the blade as shown in FIGS. 12 and 13. With reference to FIG. 14, each of the bumps 106 is again formed having a semi-spherical or domed curved shape.

In each of the alternate examples of FIGS. 6-14, the bumps are formed on a side surface of the blade with no corresponding depression or kullen on the opposite side surface. The same feature construction can be utilized in the example shown in FIGS. 1-5 as noted above. Also, any number of bumps can be employed on each of the side surfaces of the blade from many smaller sized bumps to a single elongate bump. The pair of bumps 106 in the last example disclosed and described herein can be further broken up into multiple additional bumps with spaces or gaps therebetween, if desired, more similar to the first example described herein.

In a number of the disclosed examples, the bumps have a greater lengthwise dimension than vertical height dimension relative to the blade height. In the first example, the bumps are circular. In other examples not illustrated herein, the bumps can have a greater height dimension than length dimension relative to the blade. For example, the bumps can be oval or oblong but arranged so that the narrower dimension is oriented lengthwise on the blade and the longer dimension is oriented height-wise relative to the blade. In addition, the shape and configuration of the bumps including both the shape in side view relative to the blade and the cross-sectional surface contour can vary from the examples shown and described herein. The bumps can be somewhat star shaped, square, rectangular, triangular, oval, elliptical, or the like when viewed facing the blade side surface. For functional and/or aesthetic purposes, different shaped bumps can be employed on a single knife blade if desired. The surface shape or contour of the bumps in cross-section view can also vary from the examples shown. However, the shape should be such that there is a relatively smooth transition in a vertical direction along the blade between the blade side surfaces and the bump surfaces. This is so that the bump contour will not hinder the cutting or slicing function of the implement and so as not to create a vacuum or air pockets similar to the problematic prior art kullens or Granton style blades.

The kullens 54 in the first example will effectively not create a vacuum or air pocket between an object being cut and the blade side surfaces because the bumps will create separation therebetween during cutting. As a knife edge slices through a food item or other object the bumps will force separation between the item being cut and the blade side surfaces, effectively encouraging or forcing release of the item from the blade. The raised bumps on the blade side surfaces in each example will effectively contact the food or other item being cut at the finite points of the apex of the bumps, pushing the item away from the blade, thus greatly improving the release function of the cutting implement.

As noted above, various blade materials and manufacturing processes can be used to create cutlery implements or knives in accordance with the teachings of the present invention. In one example, the bump details can be formed via features added to the tooling dies of a forging process. In such an example, the bumps will be an integral part of the blade and formed from the same material at the same time that the blade is formed. In another example, bumps could be added to a separately manufactured blade by a welding process or by use of rivets, threaded fasteners, adhesives, or the like. In one such example, a rivet or other type of fastener can be affixed to the blade and the rivet or fastener head itself can define the bump. In another such example, a silicone nubbin or other element can be separately fabricated and then applied, adhered, or joined to the blade in a suitable manner. Such processes might allow for greater manufacturing flexibility and knife variations in that a single blade style can be formed with different bumps or bump configurations and arrangements without having to change the blade tool. A stamping process can also be utilized to form such cutlery implements. The stamping dies in the process could be arranged so that material of the blade is moved or built up over sequential steps or stations to create the bumps on the blade side surfaces. Alternatively, the stamping process can be utilized to form bumps and kullens intermittently such as in the example shown in FIGS. 1-5.

The disclosed blades can be formed from various materials within the spirit and scope of the present invention. Blades with release bumps according to the invention can be formed from carbon steel, stainless steel, titanium alloy, molybdenum, carbide, diamonds, ceramic, carbon fiber, composites, or the like. The processes, such as injection molding other molding processes, utilized to manufacture non-metallic or non-steel blades can also vary so long as the process creates one or more raised bumps or protrusions on the side surfaces of the form blade.

Though mostly described herein with reference to food and food release, the present invention is potentially suitable for virtually any type of cutting implement and for cutting any type of material that requires cutting. Cutlery implements configured as described herein can greatly enhance release from the blade of items being cut. This can result in reducing consumer or worker frustration while cooking or cutting objects. The disclosed blades can have a great benefit in potentially speeding up an automated cutting process if the process is automated and reducing error or downtime caused by material sticking to blades. Cutlery implement, as used herein, is intended to be inclusive of other cutting devices, not just the hand-held kitchen knives of the disclosed examples. The release bumps can potentially be of great advantage in most any industry where release of cut material (food or otherwise) from a cutting blade is an issue. For example, rotary slicers, choppers, mandolin-type food slicers, and industrial applications, such as for cutting foams, plastics, and the like, could benefit greatly by implementing release bumps on the cutting implement or blade as disclosed herein.

In any of the disclosed embodiments or examples, it is possible that only one of the side surfaces of the blades includes a release bump or multiple release bumps. The other side could include no bumps or any other surface feature, or could include only kullens, as in the bump construction of the knife in FIGS. 1-5. Knives or cutlery implements could be fabricated with such bumps on either one of the side surfaces and not the other. This construction could be to accommodate a specific right- or left-hand user or a user preference that places the object to be cut always on one side of the knife (the no bump side) and the cut pieces on the other side of the knife (the side having release bumps). A knife having bumps on only one side is not show herein. However, any one of the cross-section views in FIGS. 4, 5, 8, 11, and 14 would show bumps on one side surface and no bumps on the opposed side surface.

The terms “bump” and “protrusion” are generally used herein to describe the raised elements on the blade side surfaces. Use of these terms is not intended to limit in any way the type of protruding or raised element. Other like terms for such elements can include, but are not limited to, bulge, convexity, distention, hump, lump, nodule, outgrowth, projection, prominence, protuberance, and the like. Use of the terms bump and protrusion are not intended to limit the release feature disclosed and described herein to any particular shape or configuration. The disclosed bumps are intended as raised features or discernable surface features that protrude from the surrounding blade side surfaces or base blade substrate. This is so, whether the blade side surfaces are relatively flat or are contoured in some manner. The bumps are such that food or other cut items are directed by the bumps or separated from the adjacent blade side surface.

The number and spacing of the bumps can also vary within the spirit and scope of the present invention. Similarly, the spacing of the bumps from the knife edge can also vary. Also, the depth or protrusion distance of the bumps from the elevation of the blade side surfaces can also vary. These bump specifics can be designed to accommodate the intended use of the cutlery implement or the intended product to be cut. Further, these bump specifics can also be determined by testing and trial and error methods based on manufacturing limitations and/or desired cutlery implement performance characteristics.

Although certain cutlery implements and released bump features for such implements have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A cutlery implement comprising:
a blade having opposed side surfaces and a knife edge along one terminal edge of the blade; and
a bump protruding from each of the opposed side surfaces and extending along and spaced from the knife edge.

2. The cutlery implement according to claim 1, further comprising:
a handle coupled to the blade.

3. The cutlery implement according to claim 1, further comprising:
a distal end on the blade and a grip end opposite the distal end; and
a handle at the grip end, the handle oriented substantially parallel with the blade.

4. The cutlery implement according to claim 1, further comprising:
a distal end on the blade and a grip end opposite the distal end; and
a handle at the grip end, the handle oriented substantially parallel with the knife edge.

5. The cutlery implement according to claim 1, wherein the bumps include a plurality of bumps spaced equidistant apart on each of opposed side surfaces.

6. The cutlery implement according to claim 1, wherein the bumps include a plurality of elongate bumps arranged lengthwise end to end along each of the opposed side surfaces.

7. The cutlery implement according to claim 1, wherein the bumps include a plurality of bumps arranged in a spaced apart array arranged lengthwise along the blade on each of the opposed side surfaces.

8. The cutlery implement according to claim 1, wherein the bumps include a plurality of circular bumps arranged spaced apart lengthwise along the blade on each of the opposed side surfaces.

9. The cutlery implement according to claim 1, wherein the bumps include a plurality of bumps spaced apart along each of the opposed side surfaces.

10. The cutlery implement according to claim 9, further comprising a plurality of depressions intermittently positioned between the plurality of bumps on each of the opposed side surfaces.

11. The cutlery implement according to claim 10, wherein each of the plurality of depressions and plurality of bumps on one of the opposed side surfaces is aligned to oppose a corresponding one of the plurality of bumps and plurality of depressions, respectively, on the other of the opposed side surfaces.

12. The cutlery implement according to claim 1, wherein the bump on each of the opposed side surfaces includes corresponding depression aligned therewith on the opposite one of the opposed side surfaces.

13. The cutlery implement according to claim 1, wherein the bumps have a rounded or continuously curved profile shape.

14. The cutlery implement according to claim 1, wherein the bumps have an angular profile shape with linear surfaces and a peak.

15. A cutlery implement comprising:
a blade having opposed side surfaces, a distal end, a grip end opposite the distal end, and a knife edge along at least part of one terminal edge of the blade between the distal and grip ends;
a handle extending from the grip end of the blade; and
a plurality of bumps protruding from and arranged lengthwise along each of the opposed side surfaces spaced from the knife edge.

16. The cutlery implement according to claim 15, wherein the handle is oriented substantially parallel with the blade.

17. The cutlery implement according to claim 15, further comprising a plurality of depressions disposed intermittently between the plurality of bumps on each of the opposed side surfaces.

18. The cutlery implement according to claim 17, wherein each of the plurality of depressions and plurality of bumps on one of the opposed side surfaces is widthwise aligned with a corresponding one of the plurality of bumps and plurality of depressions, respectively, on the other of the opposed side surfaces on the blade.

19. A cutlery implement comprising:
a blade having opposed side surfaces and a knife edge along one terminal edge of the blade; and
one or more bumps protruding from one of the opposed side surfaces and arranged along and spaced from at least a portion of the knife edge.

20. The cutlery implement according to claim 19, further comprising one or more depressions on the other of the opposed side surfaces and corresponding in number with and positioned opposite the one or more bumps.
